(19) United States
(12) Patent Application Publication
(10) Pub. No.: US 2005/0004755 A1
(43) Pub. Date: Jan. 6, 2005

(54) Navigation device

(75) Inventor: Shiro Ogura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/843,472

(22) Filed: May 12, 2004

(30) Foreign Application Priority Data
Jun. 2, 2003 (JP) 2003-156750

(51) Int. Cl. G01C 21/30

(52) U.S. Cl. 701/209

(57) ABSTRACT

When a secret mode is set, a variety of information including driving log containing destination, routes, distance covered, and direction of travel are stored in second storing means. Thus, when a user wants to keep various information unique to the user secret strictly from other users at the time the navigation device is used, the user has only to set a memory mode to a secret mode to use the device. After that, the user has only to remove the second storing means from the main body of the device to hold and manage the storing means by himself or herself.

### BACKGROUND OF THE INVENTION

1. Field of the Invention

The present invention relates to a navigation device to be occasionally used by two or more users, which gives protection to user's privacy.

2. Description of the Related Art

The conventional navigation device detects the current position of a vehicle by position detecting means such as a GPS receiver, a speed sensor, and an angular velocity sensor. Moreover, the device acquires the necessary map information for navigation by map information acquiring means such as a CD-ROM drive, a DVD-ROM drive, and a communication unit. The device sets destination and executes an instruction for a route search by input means such as an operation panel and a remote control unit. Moreover, the device guides a vehicle along a route answering the purpose by route searching means that is an information processing circuit such as a computer. The device displays route guidance, a vehicle position, and set information by output means such as a display panel and a voice synthesizer. Furthermore, the device records destination setting, registration information, route information, driving log, and the like according to input operations and the occurrence of events by storing means such as a data writable and readable semiconductor memory and a disk drive.

In such a conventional navigation device, the storing means such as the above semiconductor memory and disk drive are integrally combined with the main body of the navigation device. For this reason, where such a navigation device for a vehicle is shared among one or more users, the destination setting and registration information, route information, and driving log are recorded in the storing means of the navigation device irrespective of who used a vehicle when respective users are used the navigation device. That is, a user is exposed to danger that his or her record of activities utilizing a vehicle may be looked furtively by other users. Therefore, the device entails shortcomings in view of privacy protection to individual users.

To give an example, a navigation device devised for giving protection to user's privacy is disclosed, e.g., in JP 288296 A (p. 10) in which the navigation device distinguishes and identifies a user, who has been previously registered, by user's voice, permits exclusively the authorized user to read out private information unique to the user, which is stored in a memory or an external auxiliary storing device, and to perform data processing.

Since the traditional navigation device which is to be occasionally used by two or more users is arranged as mentioned above, the device involves a drawback that a proper measure is not adopted for privacy protection to individual users, such as in the case where private information that a user wants to keep it secret strictly leaks out to other users. In order to solve such a problem, the above-mentioned navigation device distinguishes and identifies a user, who has been previously registered, by user's voice, and permits exclusively the authorized user to process the private information unique to the user, which is stored in a memory or an external auxiliary storing unit. However, the device entails a deficiency that configuration of the device for distinguishing and identifying a user, who has been previously registered, by user's voice is too complicated, and lacks reliability on account of probable misconception thereof.

### SUMMARY OF THE INVENTION

The present invention has been made to solve the above-mentioned problems. An object of the present invention is to provide a navigation device able to securely prevent with simple configuration an invasion of privacy upon user's private information, such as in situations where user's private information containing, e.g., his or her record of activities peculiar to individual users leaks out to other users.

The navigation device according to one aspect of the present invention includes first storing means built in the main body of the device, for storing in a normal mode a variety of information including destination setting, registration information, and driving log, second storing means arranged removably from the main body of the device, for storing a variety of information including the destination setting, registration information, and driving log when a secret mode is set; and memory mode selecting means for selecting the first storing means when the normal mode is set, and selecting the second storing means when the secret mode is set, depending on which mode is set by the input means.

Therefore, according to one aspect of the present invention, when a user wants to keep the private information including his or her record of activities secret strictly when the user used the navigation device, the user has only to select the secret mode to store the private information in the second storing means. After that, the user has only to remove the second storing means from the main body of the device to hold and manage the means by himself or herself. Therefore, the navigation device securely protects with a simple configuration the private information that the user wants to keep it secret strictly from other users when the user used the device.

The navigation device according to another aspect of the present invention includes storing means built in the main body of the device and having a first storing area for storing in a normal mode a variety of information including the destination setting, registration information, and driving log; a second storing area for storing in a secret mode a variety of information including the destination setting, registration information, and driving log; memory mode selecting means for selecting the first storing area when the normal mode is set, and selecting the second storing area when the secret mode is set, depending on which mode is set by the input means; and deleting means for deleting a variety of information including the destination setting, registration information, and driving log, which has been stored in the second storing area, when the secret mode is canceled.

Therefore, according to the present invention, when the user wants to keep the private information including his or her record of activities secret strictly from other users when the user used the navigation device, the user has only to select the secret mode to store the private information in the second storing area, and the user has only to delete the private information stored in the second storing area by canceling the secret mode. As a result, the user keeps the private information secret from other users when the user used the navigation device. For this reason, the navigation device securely protects with a simple configuration the private information that the user wants to keep it secret strictly from other users.

### BRIEF DESCRIPTION OF THE DRAWINGS

FIG. 1 is a block diagram showing configuration of a navigation device according to a first embodiment of the present invention;

FIG. 2 is a timing chart illustrating operations of the navigation device;

FIG. 3 is a block diagram showing configuration of a navigation device according to a second embodiment of the present invention; and

FIG. 4 is a timing chart illustrating operations of the navigation device.

### DETAILED DESCRIPTION OF THE PREFERRED EMBODIMENTS

Preferred embodiments of the present invention will now be described below with reference to the attached drawings.

### First Embodiment

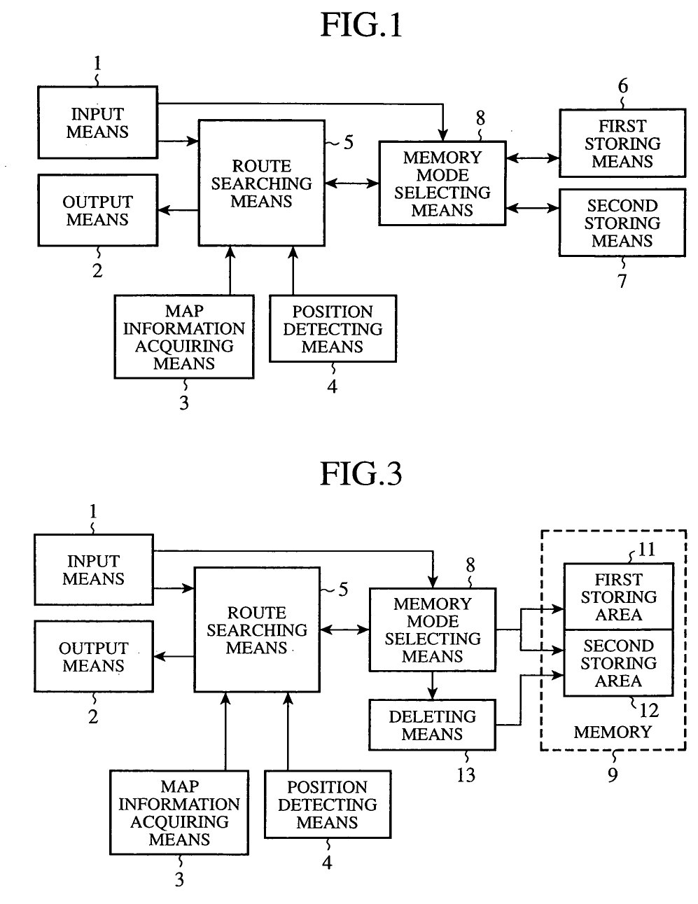

FIG. 1 is a block diagram showing configuration of a navigation device according to the first embodiment. The navigation device has a normal mode and a secret mode as a form of utilization of a memory. The secret mode is a memory mode in which a record of a variety of information including the set destination, routes, driving log abides nothing in the main body of the navigation device. The normal mode is a memory mode in which a record of a variety of information including set destination, routes, and driving log is written and kept in the memory built in the main body of the navigation device.

The navigation device includes input means 1, output means 2, map information acquiring means 3, position detecting means 4, route searching means 5, first storing means 6, second storing means 7, and memory mode selecting means 8.

The input means 1 has an input function of setting and canceling a secret mode. The input method may involve a menu button realized by a dedicated switch or of a touch-panel switch. Alternatively, the input method may have an arrangement such that implementation of the secret mode itself is not likely to recognize by operations such as simultaneous depressing of a plurality of buttons or long-time depressing of a button without displaying an exclusive menu, an operation from a dedicated remote control unit, and an operation from a cellular phone.

The output means 2 may be a display panel, or a voice synthesizer, and is for giving guidance of routes and displaying a vehicle position and set information.

The map information acquiring means 3 may be a CD-ROM drive, a DVD-ROM drive, or a communicating unit, and is for acquiring map information necessary for navigation.

The position detecting means 4 may be a GPS receiver, a speed sensor, or an angular velocity sensor, and is for sensing a vehicle position.

The route searching means 5 may be an information processing circuit such as a computer, and has a capability of searching a route answering the purpose.

The first storing means 6 may be a semiconductor memory built in the navigation device, and is for storing in a normal mode a variety of information including destination setting, registration information, and driving log.

The second storing means 7 is a removable memory from the navigation device, and may be, e.g., a SD (Secure Digital) card, a memory stick, a CF (Compact Flash) card, a Smart Media, or a multimedia card. In the second storing means 7 is stored a variety of information including destination setting, registration information, and driving log during a secret mode.

Moreover, the second storing means 7 may also be arranged so as to include selecting means for allowing a user to select a variety of information to be stored in the second storing means 7. To materialize the selecting means, it needs to previously set and register attributes of information (e.g., driving log such as a telephone number, destination registered based on the telephone number, through places, routes, and the like) to be stored in the second storing means 7 by the input means 1, and then stores only the attributes of information set and registered in the second storing means 7.

In addition, the second storing means 7 may implement a personal identification capability such as read/write protection by, e.g., password.

The memory mode selecting means 8 maintains a memory mode in either a secret mode or a normal mode set by the input means 1, and selects the first storing means 6 or the second storing means 7 depending on which mode is set by the input means.

The operation of the first embodiment will now be described below.

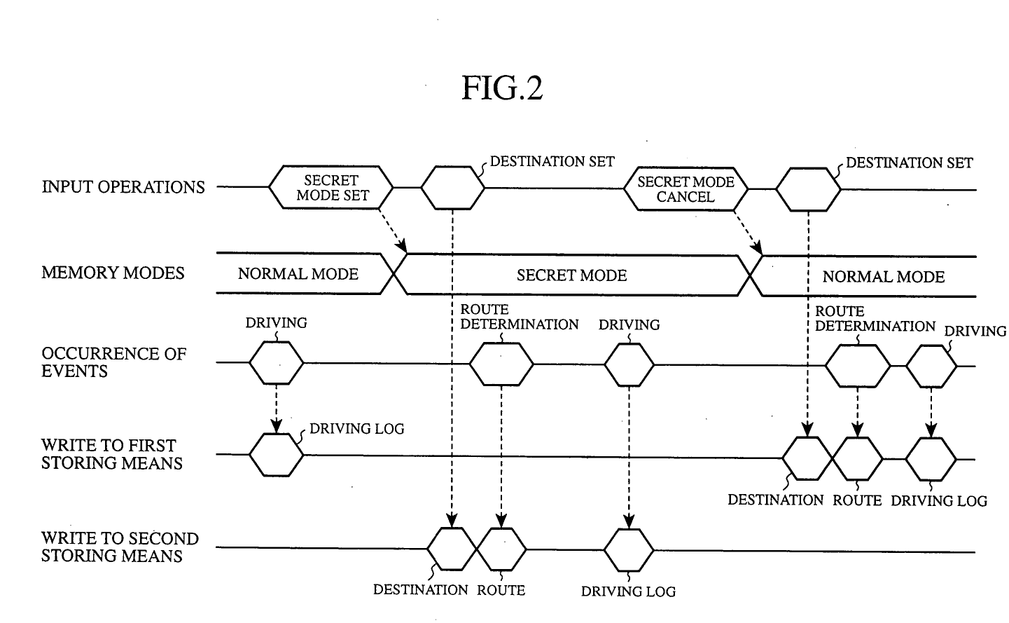

FIG. 2 is a timing chart illustrating operations of the navigation device of the first embodiment. The operations of the navigation device will now be described referring to the timing chart. The navigation device operates in a normal mode unless a mode is set to a secret mode. In the normal mode, driving log containing destination set by an input operation via the input means 1, routes searched and determined by the route searching means 5, distance covered, and direction of travel are written in the first storing means 6. The various information stored in the first storing means 6 can be read by unspecified users if necessary, and exploited for navigation.

When a memory mode is switched from the normal mode to the secret mode by the input means 1, the memory mode is changed from the normal mode selected up to that time to the secret mode. Then, the second storing means 7 is selected as a memory in which is written a variety of information including driving log containing destination set by an input operation via the input means 1, routes searched and determined by the route searching means 5, distance covered, and direction of travel. The conditions under which the second storing means 7 is selected include that the secret mode has been selected and that the second storing means 7 has been inserted in a predetermined inserting portion of the main body of the navigation device.

In the secret mode, various information including driving log containing destination set by an input operation via the input means 1, routes searched and determined by the route searching means 5, distance covered, and direction of travel are stored in the second storing means 7.

Therefore, when a user of the navigation device sets a memory mode to the secret mode, and wants to keep a variety of information secret strictly from other users, including driving log containing destination, routes, distance covered, and direction of travel unique to the user stored in the second storing means 7 at the time the user used the navigation device, the user has only to remove the second storing means 7 from the main body of the navigation device to hold and manage the means by himself or herself. And, when the user uses the navigation device again, the user just inserts the second storing means 7 held by the user into a predetermined inserting portion of the main body of the navigation device, and sets the memory mode to the secret mode. Doing so, a user can use a various information unique to the user, including driving log containing destination, routes, distance covered, and direction of travel, which has been stored in the second storing means 7 inserted thereinto as described above, to use the navigation device.

In addition, if the second storing means 7 should fall into another's hands accidentally, the provision of a personal identification capability such as read/write protection by password in the second storing means 7 falls in difficulties in exploiting the information unique to the user stored in the second storing means 7, which prevents leakage of the information unique to the user stored in the second storing means 7 to the outside, thereby protecting user's privacy.

As mentioned above, according to the first embodiment, there is offered a navigation device in which a secret mode is provided in addition to a normal mode; when a user wants to keep private information secret strictly, including his or her record of activities, the secret mode is selected and the second storing means 7 in which the private information including driving log containing destination, routes, distance covered, and direction of travel are stored is removed from the main body of the navigation device to keep the private information unique to a user secret strictly from other users. This securely prevents with a simple configuration an invasion of privacy upon the private information of individual users.

### Second Embodiment

FIG. 3 is a block diagram showing configuration of a navigation device according to the second embodiment. The navigation device according to the second embodiment is arranged such that a storing area of a memory 9 mounted on the main body of the navigation device is divided into two storing areas, i.e., a first storing area 11 and a second storing area 12, the former of which is used in a normal mode, and the later of which is used in a secret mode. Furthermore, the navigation device includes deleting means 13, which has a function of deleting all various information including driving log containing destination, routes, distance covered, and direction of travel, which has been stored in the second storing area 12 when the normal mode is set by the input means 1 during the secret mode.

The operation of the second embodiment will now be described below.

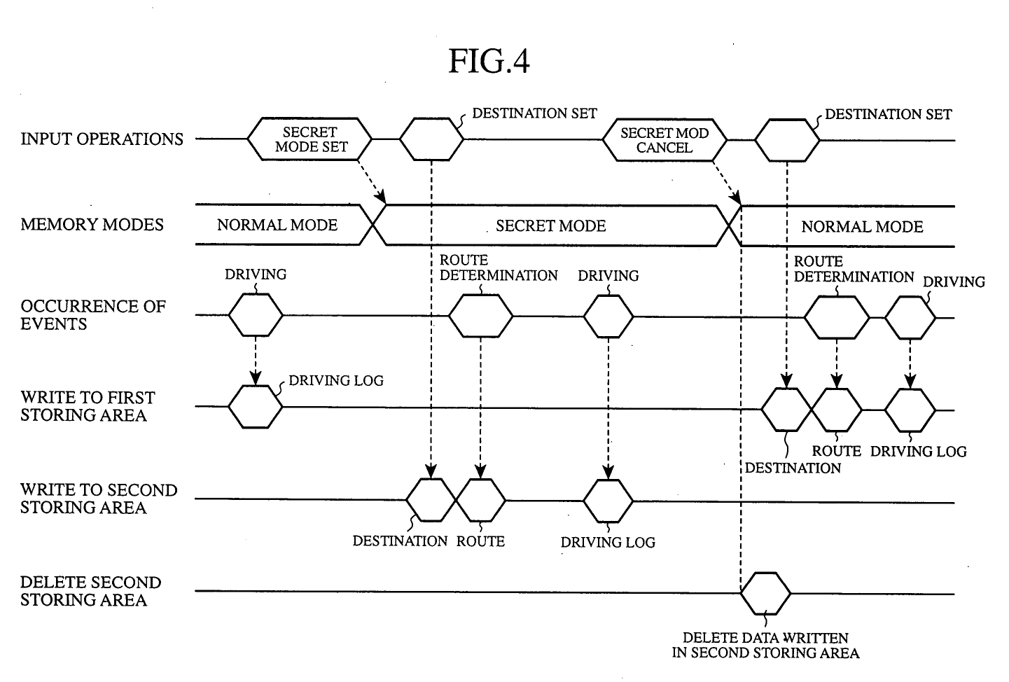

FIG. 4 is a timing chart illustrating operations of the navigation device of the second embodiment. The explanation of operations illustrated in the timing chart shown in FIG. 4 common to that illustrated in the timing chart shown in FIG. 2 is omitted for brevity's sake.

The navigation device also operates in the normal mode unless a memory mode is set to a secret mode. Moreover, operations of the device when the mode is switched to the secret mode by an operation via the input means 1 during a normal mode are the same as that illustrated in the timing chart of FIG. 2 of the first embodiment. That is, the second storing area 12 is selected as a portion in which is written a variety of information including driving log containing destination set by an input operation via the input means 1, routes searched and determined by the route searching means 5, distance covered, and direction of travel. The variety of information including the driving log containing destination, routes, distance covered, and direction of travel are stored in the second storing area 12.

Further, when a memory mode is switched from the secret mode to the normal mode again, all the variety of information including the driving log containing destination, routes, distance covered, and direction of travel stored in the second storing area 12 are deleted by the deleting means 13.

Accordingly, according to the second embodiment of the present invention, there is offered a navigation device in which the secret mode is provided in addition to the normal mode. When a user wants to keep the user's private information secret strictly from other users, including his or her record of activities, the secret mode is selected and the private information including driving log containing destination, routes, distance covered, and direction of travel are stored in the second storing area 12; and all the private information unique to the user, including his or her record of activities stored in the second storing area 12 are deleted when the secret mode is canceled. As a result, the private information including his or her record of activities at the time the user used the navigation device can be kept secret strictly from other users. This securely prevents with simple configuration an invasion of privacy upon the private information of individual users.

1. A navigation device including input means for doing various inputs; output means for displaying a variety of information including route guidance, a vehicle position, and set information; map information acquiring means for acquiring map information; position detecting means for detecting a vehicle position based on detection signals from various sensors; and route searching means for searching a route answering the purpose, the navigation device comprising:
first storing means built in the main body of the device, for storing in a normal mode a variety of information including destination setting, registration information, and driving log;
second storing means arranged removably from the main body of the device, for storing in a secret mode a variety of information including the destination setting, registration information, and driving log; and
memory mode selecting means for selecting the first storing means when the normal mode is set, and selecting the second storing means when the secret mode is set, depending on which mode is set by the input means.

2. The navigation device according to claim 1, wherein the second storing means has a personal identification capability.

3. The navigation device according to claim 1, wherein a variety of information stored in the second storing means is selectable by a user.

4. A navigation device including input means doing various inputs; output means for displaying a variety of information including a route guidance, a vehicle position, and set information; map information acquiring means for acquiring map information; position detecting means for detecting a vehicle position based on detection signals from various sensors; and route searching means for searching a route answering the purpose; the navigation device comprising:
storing means built in the main body of the device and having a first storing area for storing in a normal mode a variety of information including destination setting, registration information, and driving log, and a second storing area for storing in a secret mode a variety of information including the destination setting, registration information, and driving log;
memory mode selecting means for selecting the first storing area when the normal mode is set, and selecting the second storing area when the secret mode is set, depending on which mode is set by the input means; and
deleting means for deleting a variety of information including the destination setting, registration information and driving log, which has been stored in the second storing area, when the secret mode is cancelled.

5. The navigation device according to claim 4, wherein a variety of information stored in the second storing area is selectable by a user.
